(19) United States
(12) Patent Application Publication
(10) Pub. No.: US 2011/0049248 A1
(43) Pub. Date: Mar. 3, 2011

(54) Electronic Device Comprising a Microcircuit Card

(75) Inventor: Jean-Marc Meslin, Deuil La Barre (FR)

(73) Assignee: OBERTHUR TECHNOLOGIES, Levallois Perret (FR)

(21) Appl. No.: 12/875,392

(22) Filed: Sep. 3, 2010

(30) Foreign Application Priority Data
Sep. 3, 2009 (FR) 09/56003

(51) Int. Cl. G06K 19/07

(52) U.S. Cl. 235/492

(57) ABSTRACT

The card (12) comprises a first face (14A) supporting a first contact interface (18) connected to the microcircuit (16) and a second face (14B) supporting a customization element (22) of the device (10). The device (10) comprises a support (24) for reading the card (12) supporting a second contact interface (26) configured to cooperate with the first interface (18) by electrical contact. More particularly, the support (24) comprises a package (28) provided with an external face (28S) defining a location (38) for receiving the card (12) inside which the second interface (26) is essentially flush. Moreover, the card (12) is attached by adhesion on that location (38), making the two interfaces (18, 26) cooperate with each other while leaving the second face (14B) supporting the customization element (22) visible.

### RELATED APPLICATIONS

This application claims the priority of French patent application Ser. No. 09/56003 filed Sep. 3, 2009, the entire content of which is hereby incorporated by reference.

### FIELD OF THE INVENTION

The present invention concerns the technical field of the customization of portable or pocket electronic devices, such as electronic keys in particular.

It more particularly, but not specifically concerns USB (Universal Serial Bus) memory keys, used in particular to transport and store computer data.

### BACKGROUND OF THE INVENTION

In general, an electronic key comprises a set of electronic circuits, hereinafter referred to as electronic means of the key, generally supported by a printed circuit support, such as a PCB, the whole thing being housed inside a package.

The key is also provided with a USB connector adapted to engage with a port in compliance with the USB standard for an external terminal, such as a personal computer. This connector generally comprises a first portion protruding from the package and a second portion electrically connected to the electronic means.

In many applications, in particular in the fields of public transportation, security, etc., it is desirable to customize the electronic key in relation to the key's owner so as to allow its identification and authentication. Thus, it is known to associate a visual of the key with personal data stored for example by the electronic means of the key.

Already known from the state of the art, in particular from document EP 1 535 240, is a customizable electronic device comprising a microcircuit card provided with an external contact interface in compliance with a predefined standard for microcircuit cards as well as a card support, the card support comprising a connector according to a predefined memory key standard, such as a USB connector.

The card in particular comprises a customization element, such as a photograph, identification number, etc., on one of its faces.

In this document, the card support also comprises a housing for receiving the card provided with a card reader terminal. This card reader terminal comprises a plurality of connectors arranged to come into contact with the external interface of the card when the latter part is inserted into the housing.

Thus, the manufacture of the support can be standard because only the card supports the customization elements of the key and can be inserted into the housing at the last minute.

However, this device has the drawback of requiring a very precise adjustment of the dimensions of the housing in relation to the card to avoid any untimely withdrawal of the latter from the housing. To limit the risks of losing the card, the document provides for forming a passage for a chain at an inlet of the slot or possibly a locking device.

This makes the manufacture of the electronic device complex and consequently causes relatively high production costs.

### SUMMARY OF THE INVENTION

One object of the invention is to provide an alternative to the above-described solution with reduced production costs.

This and other objects are attained in accordance with one aspect of the present invention directed to an electronic device comprising a microcircuit card comprising a first face supporting a first contact interface connected to the microcircuit and a second face supporting a customization element of the device, and a reading support for the card supporting a second contact interface configured to cooperate with the first interface by electrical contact. The support comprises a package provided with an outer face defining a location for receiving the card inside which the second interface is essentially flush. The card is attached by adhesion on this location causing the two interfaces to cooperate with each other such that the customization element is visible.

Because the card can be attached by adhesion, this limits the loss risks while simplifying the manufacture of the device. Moreover, the second face, opposite the first face supporting the first interface, is directly visible from the outside of the device. Because the card support does not support the microcircuit or the customization element, its manufacture can be done independently of the customization of the device.

Moreover, traditional equipment for printing chip cards can be used to carry out the graphic customization of the device because the graphic customization element as well as the microcircuit able to store the device's owner's personal elements are grouped together in the card.

A device according to an embodiment of the invention can include one or several of the following features:

the support comprises means for communicating data with external equipment connected to the second interface such that data can be exchanged between the microcircuit and the means when the two interfaces cooperate;

the communication means comprises a connector according to a predefined memory key standard and/or a near field communication antenna;

the support comprises means for converting a communication protocol of the microcircuit into a communication protocol of the means and vice versa;

the customization element is associated with at least one customization data stored in the microcircuit and accessible using communication means;

the receiving location is defined by an edging forming a positioning frame for the card on the location;

the frame and the card have a complementary key profile in order to impose a mounting direction of the card on the location;

the first interface comprises a plurality of contact pads and the second interface comprises a plurality of brush connectors protruding on the location;

the card comprises a body with a format smaller than the ID-1 format defined by standard ISO-7816.

Another aspect of the invention concerns a microcircuit card according to a card of the device according to the invention, characterized in that the card comprises, on the first face, a layer of self-seal adhesive material arranged to essentially surround the first interface.

Preferably, the layer of adhesive material is protruding in relation to the first interface. This makes it possible to avoid directly exposing the microcircuit to shocks or various impacts.

### BRIEF DESCRIPTION OF THE DRAWINGS

FIG. 1 shows an electronic device with a customizable USB key according to an embodiment of the invention;

FIG. 2 is a top view of a card according to an embodiment of the invention;

FIG. 3 is a bottom view of the card shown in FIG. 2;

FIG. 4 is a cross-sectional view along line 4-4 of FIG. 3;

FIG. 5 shows a card body provided with a pre-cut defining the card of FIG. 2;

FIG. 6 shows the electronic device of FIG. 1 without the card;

FIG. 7 is a cross-sectional view along line 7-7 of FIG. 6.

### BRIEF DESCRIPTION OF THE DRAWINGS

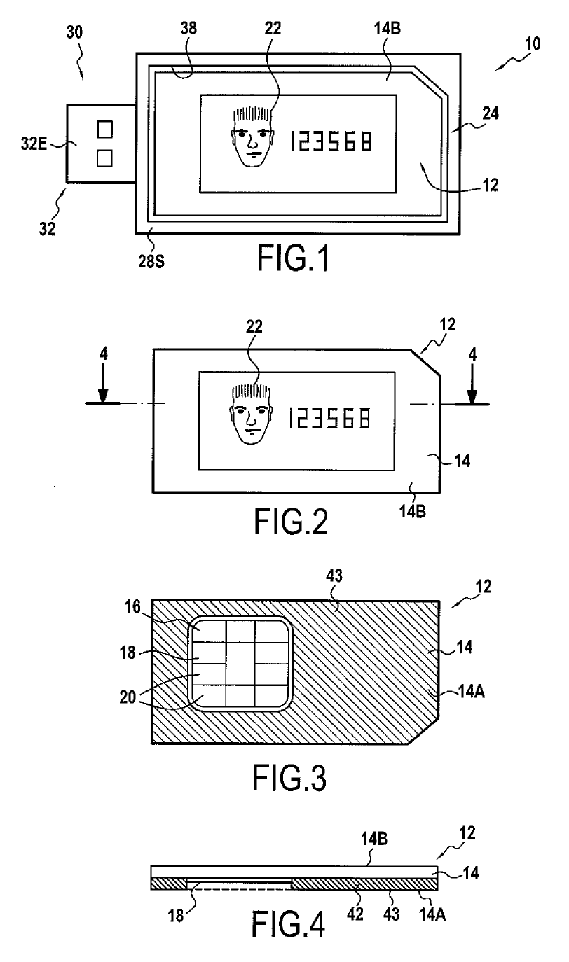

FIG. 1 shows an electronic device according to the invention designated by the general reference 10. In the described example, the electronic device is an electronic key 10 of the USB connector type.

This electronic device 10 in particular comprises a microcircuit 16 card 12 shown in detail in FIGS. 2 to 5. The card 12 comprises a card body 14 defining first 14A and second 14B opposite faces.

More particularly, this card 12 is provided on the first face 14A with a first contact interface 18 connected to the microcircuit 16. This first interface 18 preferably comprises a plurality of connecting pads 20. In this example, the card 12 is in compliance with standard ISO 7816 for microcircuit cards. This standard defines in particular the dimensions, location and allocation of the connecting pads, traditionally designated C1 to C8, flush on the surface of the card 12.

Preferably, the body 14 of the card 12 comprises a format smaller than format ID-1 defined by standard ISO-7816. In the illustrated example, the body 14 has outer dimensions in compliance with those defined by format ID-000, typically used for “SIM cards.”

As shown in detail in FIG. 3, the connecting pads C1 to C8 are arranged in two rows of four pads, C1 to C4 and C5 to C8, respectively, parallel to each other.

The first interface 18 and the microcircuit 16 form a microcircuit module comprising in particular a module support not shown in the figures and defining two opposite faces, one of the faces supporting the first interface 18 and the opposite face supporting the microcircuit 12. The first interface 18 and the microcircuit 12 are connected to each other electrically, for example by electrical wires passing through vias formed in the module support. The microcircuit module is for example housed in a receiving cavity formed in the body 14 of the card 12.

Moreover, more specifically, the second face 14A of the card 12 supports a graphic customization element 22 of the card as shown in FIG. 2. For example, the customization element 22 comprises a chain of alphanumeric characters, a photograph or drawing, etc.

The graphic customization element 22 comprises at least one data stored in the microcircuit 16 of the module.

Preferably, the graphic customization element 22 is printed on the first face 14A of the card 12, for example using printing techniques known by those skilled in the art working in the field of printing chip cards.

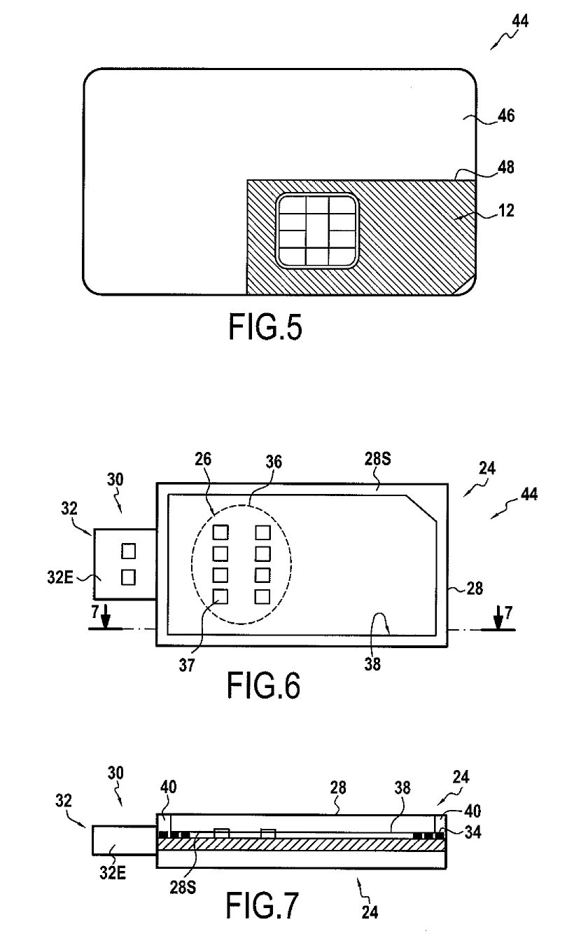

The electronic device 10 also comprises a reading support 24 of the card supporting a second contact interface 26 configured to cooperate with the first interface 18 by electrical contact. This support 24 comprises a package 28. In this example, the package 26 is essentially parallelepiped in shape (FIGS. 6 and 7). It is for instance produced in a material comprising a plastic material.

Preferably, the support 24 comprises means 30 for communicating data with outside equipment (not shown).

For example, the communication means 30 comprises a connector 32 according to a predefined USB key standard. In the illustrated example, the connector 32 is of the USB type and is intended to engage with a USB port of an outside piece of equipment (not shown) such as, for example, a personal computer.

The communication means 30 also comprises, in this example, a near field communication antenna 34.

Alternatively, the communication means 30 can comprise either the connector 32 or the antenna 34, or a wireless communication module of the WIFI type, etc. (not shown).

Preferably, the second interface 26 is connected to the communication means 30 such that the two interfaces 18 and 26 are capable of cooperating with each other to authorize an exchange of data between the communication means 30 and the microcircuit 16.

Thus, the second interface 26 forms a read head 36 of the card 12 and for example comprises a plurality of brush connectors 37. Thus, this second interface 26 must take the standard used by the first interface 18 into account.

Moreover, preferably, the support 24 comprises means (not shown) for converting a protocol used by the microcircuit 16 into a protocol used by the communication means 30 and vice versa.

More precisely, the housing 28 of the support 24 at least partially incorporates the communication means 30 as shown for instance in FIGS. 6 and 7. One thus sees in particular that the USB connector comprises an external portion 32E, capable of engaging with a USB port of external equipment, and an internal portion (not shown) housed inside the housing 28.

Moreover, preferably, the graphic customization element 22 is associated with at least one customization data stored in the microcircuit 16 and accessible using the communication means 30.

More particularly, the housing 28 has an outer face 28S defining a location 38 for receiving the card 12 inside which the second interface 26 is essentially flush.

Thus, more precisely, the card 12 is attached by adhesion on this location 38 such that the two interfaces 18 and 26 cooperate and the customization element 22 is visible.

Preferably, as seen in particular in FIG. 7, the receiving location 38 is defined by an edging 40 forming a frame for positioning the card 12 on the location 38. For example, the frame 40 and the card 12 have a complementary key profile in order to impose a mounting direction of the card 12 on the location 38 (FIGS. 3 and 6).

Preferably, the card 12 comprises, on the first face 14A, a layer 42 of self-seal adhesive material arranged to essentially surround the first interface 18. As visible in FIG. 4, the layer of adhesive material 42 is protruding in relation to the first interface 18. This makes it possible in particular to offer protection from shocks and attacks on the microcircuit 16, since the latter is not directly exposed, but on the contrary is situated withdrawn in relation to the layer. Moreover, preferably, before its first use, the layer of material 42 is protected by a removable non-adhesive film 43.

The electronic device 10 previously described can be provided in the form of a customization assembly 44 comprising the card reading support 24 and a card body 46 with dimensions corresponding to those defined by format ID-1 according to standard ISO 7816 provided with a detachable pre-cut 48 defining the card 12, as shown in FIG. 5.

We will now describe the main functional aspects of a device according to the invention, provided for example in the form of the customization assembly 44.

The user then detaches the card 12 from the card body 46 and removes the non-adhesive protective film 43 so as to reveal the self-adhesive surface of the layer 42. He then positions the card 12 in the location 38 provided to that end on the support 24 while respecting the positioning instructions provided by the respective profiles of the card 12 and the location 38.

The two interfaces 18, 26 are then, in this usage position, opposite each other such that they can cooperate with each other, in particular in case of electronic or magnetic stress of the means 30 for communicating data from the device 10.

Thus, for example, the user approaches the electronic device of external equipment such as a near field external card reader, and a current circulates inside the antenna 34 making it possible to establish a near field connection between the external equipment and the microcircuit 16. The user may potentially insert the USB-type connector into external equipment, such as a personal computer, and the microcircuit 16 can thus exchange data with that computer via the connector.

The presentation of the card in self-adhesive “sticker” form is particularly advantageous because it makes it possible in particular to simplify the manufacture of the card reading support. In particular, the card reading support must simply include an essentially planar surface on which the card can be stuck.

It is understood that the embodiments described above are in no way limiting and may receive any desired modification without going beyond the scope of the invention. In particular, the invention is also applicable to any electronic device comprising a card reading support provided with an essentially planar surface having dimensions essentially equal to those of the card.

We claim:

1. An electronic device comprising a microcircuit card comprising a first face supporting a first contact interface connected to the microcircuit and a second face supporting a customization element of the device, and a support for reading the card supporting a second contact interface configured to cooperate with the first interface by electrical contact, wherein the support comprises a housing provided with an external face defining a location for receiving the card inside which the second interface is essentially flush, and wherein the card is attached by adhesion on that location, making the first and second interfaces cooperate with each other such that the customization element is visible.

2. The device according to claim 1, wherein the support comprises communication means for communicating data with outside equipment connected to the second interface such that data can be exchanged between the microcircuit and the communication means when the first and second interfaces cooperate.

3. The device according to claim 2, wherein the communication means comprises a connector in compliance with a predefined USB key standard and/or a near field communication antenna.

4. The device according to claim 2, wherein the support comprises means for converting a communication protocol of the microcircuit into a communication protocol of the communication means and vice versa.

5. The device according to claim 2, wherein the customization element is connected to at least one customization data stored in the microcircuit and accessible using the communication means.

6. The device according to claim 1, wherein the location is defined by an edging forming a positioning frame of the card on the location.

7. The device according to claim 6, wherein the frame and the card have a complementary key profile in order to impose a mounting direction of the card on the location.

8. The device according to claim 1, wherein the first interface comprises a plurality of connecting pads and the second interface comprises a plurality of brush connectors protruding on the location.

9. The device according to claim 1, wherein the card comprises a body with a format smaller than format ID-1 defined by standard ISO-7816.

10. A microcircuit card according to a card of the device according to claim 1, wherein the card comprises, on the first face, a layer of self-adhesive material arranged to essentially surround the first interface.

11. The card according to the claim 10, wherein the microcircuit is arranged withdrawn in relation to the raised layer of adhesive material.
